(19) United States
(12) Patent Application Publication
(10) Pub. No.: US 2026/0301477 A1
(43) Pub. Date: Oct. 1, 2026

(54) SYSTEM AND METHOD

(71) Applicant: TOYOTA JIDOSHA KABUSHIKI KAISHA, Toyota-shi (JP)

(72) Inventors: Hiroshi ABE, Kasukabe-shi (JP); Kazuya OKADA, Tokyo (JP); Toru FURUSAWA, Yokohama-shi (JP); Tomoko MASUDA OKUZAWA, Tokyo (JP)

(73) Assignee: TOYOTA JIDOSHA KABUSHIKI KAISHA, Toyota-shi (JP)

(21) Appl. No.: 19/448,411

(22) Filed: Jan. 14, 2026

(30) Foreign Application Priority Data
Mar. 27, 2025 (JP) 2025-054142

(51) Int. Cl. G07C 5/00; H04W 4/44

(52) U.S. Cl. CPC G07C 5/008; H04W 4/44

(57) ABSTRACT

The system includes: a generator that uses renewable energy; a battery configured to store electric power supplied from the generator; a first communication unit that is powered by the battery and configured to provide an access network; a second communication unit that is powered by the battery and configured to connect to a wide area network; a server that is powered by the battery and configured to process a predetermined request from one or more terminals through the first communication unit; a storage unit configured to store data received from the one or more terminals in association with the predetermined request; and a control unit configured to, when remaining energy of the battery reaches a predetermined threshold, instruct the server to start uploading the data stored in the storage unit to a predetermined device through the second communication unit.

### CROSS-REFERENCE TO RELATED APPLICATION

This application claims priority to Japanese Patent Application No. 2025-054142 filed on March 27, 2025. The disclosure of the above-identified application, including the specification, drawings, and claims, is incorporated by reference herein in its entirety.

### BACKGROUND

### 1. Technical Field

The present disclosure relates to mobile communication systems.

### 2. Description of Related Art

A modular mobile base station equipped with a solar or wind generator and a battery has been disclosed (for example, Japanese Unexamined Patent Application Publication No. 2013-197793 (JP 2013-197793 A)).

### SUMMARY

An object of the present disclosure is to provide a system and a method that allow communication through a base station to continue for a longer period of time in a mobile communication system including a base station and a server that are powered by a battery.

One aspect of the present disclosure is a system including:

a generator that uses renewable energy;

a battery configured to store electric power supplied from the generator;

a first communication unit that is powered by the battery and configured to provide an access network;

a second communication unit that is powered by the battery and configured to connect to a wide area network;

a server that is powered by the battery and configured to process a predetermined request from one or more terminals through the first communication unit;

a storage unit configured to store data received from the one or more terminals in association with the predetermined request; and

a control unit configured to, when remaining energy of the battery reaches a predetermined threshold, instruct the server to start uploading of the data stored in the storage unit to a predetermined device through the second communication unit.

Another aspect of the present disclosure is a method implemented in a system including

a generator that uses renewable energy,

a battery configured to store electric power supplied from the generator,

a first communication unit that is powered by the battery and configured to provide an access network,

a second communication unit that is powered by the battery and configured to connect to a wide area network,

a server that is powered by the battery,

a storage unit, and

a control unit.

The method includes:

processing, by the server, a predetermined request from one or more terminals through the first communication unit;

storing, by the server, data received from the one or more terminals in association with the predetermined request; and

when remaining energy of the battery reaches a predetermined threshold, instructing, by the control unit, the server to start uploading of the data stored in the storage unit to a predetermined device through the second communication unit.

The present disclosure allows communication through a base station to continue for a longer period of time in a mobile communication system including a base station and a server that are powered by a battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows an example of the configuration of a mobile communication system;

FIG. 2 shows an example of the hardware configuration of a control device;

FIG. 3 shows an example of the functional configuration of the control device;

FIG. 4 is a flowchart showing an example of a startup control process executed by the control device; and

FIG. 5 is a flowchart showing an example of an upload prediction process executed by the control device.

### DETAILED DESCRIPTION OF EMBODIMENTS

Combining an edge server with a mobile base station improves convenience in situations such as disasters. However, since the edge server consumes power to perform processing, the energy remaining for communication decreases and the available communication time may be shortened.

One aspect of the present disclosure is a system including: a generator that uses renewable energy; a battery configured to store electric power supplied from the generator; a first communication unit configured to provide an access network; a second communication unit configured to connect to a wide area network; a server; a storage unit; and a control unit. The first communication unit, the second communication unit, and the server are powered by the storage battery. The server is configured to process a predetermined request from one or more terminals through the first communication unit, and store data received from the one or more terminals in association with the predetermined request. The control unit is configured to, when remaining energy of the battery reaches a predetermined threshold, instruct the server to start uploading the data stored in the storage unit to a predetermined device through the second communication unit.

The generator that uses renewable energy may be, for example, a solar panel, a micro-hydroelectric turbine, or a small wind turbine. Conceptually, the first communication unit and the second communication unit together constitute a base station. For example, the first communication unit may be a Wi-Fi access point, and the second

communication unit may be a satellite communication base station. Alternatively, the first communication unit may be a Wi-Fi access point, and the second communication unit may be a 5G base station. Alternatively, the first communication unit may be a 4G LTE base station, and the second communication unit may be a 5G base station. Alternatively, the first communication unit and the second communication unit may be implemented as a single base station of a mobile communication scheme such as 5G. In this case, the first communication unit provides an access network of the mobile communication scheme, and the second communication unit connects to a core network of the mobile communication scheme.

The control unit is, for example, a computer. The server and the control unit may be separate devices or the same device. The server is, for example, an edge server that processes a predetermined request sent from one or more terminals. Examples of the predetermined request include requests of applications with relatively low real-time requirements, such as requests to upload video data scheduled for distribution in a video-streaming service or requests to send emails.

According to the above aspect of the present disclosure, execution of data uploads through a wide area network is limited to cases where electric power supplied by the generator utilizing renewable energy has been stored in the battery to an amount greater than or equal to a predetermined threshold. Uploading data to a predetermined device through the wide area network is one of the processes that consume a large amount of power. By collectively executing data uploads through the wide area network when sufficient power has been stored in the battery, power consumption associated with the uploads can be reduced. As a result, devices other than the server, such as user terminals, can continue communication through the wide area network for a longer period of time.

In the above aspect of the present disclosure, the control unit may further be configured to predict a power generation amount of the generator, predict an upload timing based on the prediction result of the power generation amount, and notify the one or more terminals of the predicted upload timing, or present the predicted upload timing by a predetermined method. Since the power generation amount of the generator utilizing renewable energy greatly varies depending on factors such as weather conditions, it is difficult for a user to know when the upload will actually be executed. According to the above aspect of the disclosure, the upload timing can be made recognizable to the user.

In another aspect of the present disclosure, the present disclosure may be embodied as a method in which the server and the control unit of the above system execute the above processing. In still another aspect of the disclosure, the present disclosure may be embodied as a program for causing a computer to execute the above method, and as a non-transitory computer-readable recording medium storing the program.

Hereinafter, embodiments of the present disclosure will be described with reference to the drawings. The configurations of the following embodiments are illustrative, and the present disclosure is not limited to those configurations.

### First Embodiment

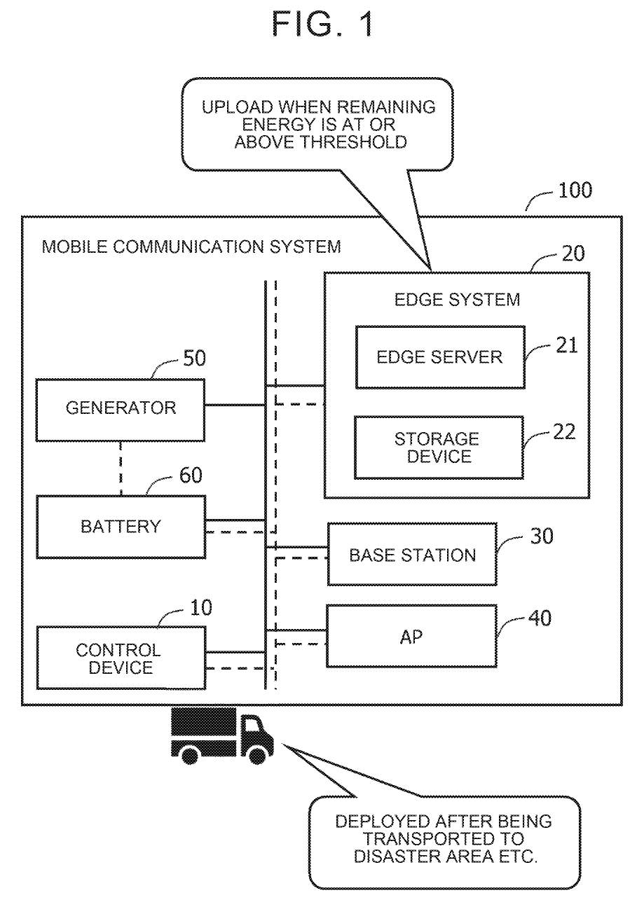

FIG. 1 shows an example of the configuration of a mobile communication system 100. The mobile communication system 100 is a packaged system that is transported by a mobile object to a disaster area or the like and deployed on site to provide communication services in the deployed area. The mobile object that transports the mobile communication system 100 may be, for example, a vehicle, a railway vehicle, a ship, an aircraft, or a drone. The mobile communication system 100 may also be configured as an integrated system that includes the mobile object as one of its components.

The mobile communication system 100 includes a control device 10, an edge system 20, a base station 30, an access point (AP) 40, a generator 50, and a battery 60. In FIG. 1, signal lines are shown as continuous lines and power lines as dashed lines. The control device 10, the edge system 20, the base station 30, the AP 40, the generator 50, and the battery 60 may be connected by a communication network such as a local area network (LAN) or optical line, or may be electrically connected by a bus. The control device 10, the edge system 20, the base station 30, the AP 40, the generator 50, and the battery 60 may all be connected to a single network, or, for example, the network between the base station 30 and the AP 40 may be a separate network.

The generator 50 uses renewable energy. The renewable energy used by the generator 50 may be, for example, solar, wind, or hydro energy. The generator 50 is a relatively small generator such as a solar panel, a small wind turbine, or a micro-hydro turbine. Electric power supplied by power generation equipment that uses renewable energy is also referred to as renewable power. The battery 60 stores renewable power generated by the generator 50.

The control device 10, the edge system 20, the base station 30, and the AP 40 operate using the battery 60 as their power source. The AP 40 is, for example, a Wi-Fi access point or a part of a base station of a mobile communication scheme such as 5G. The AP 40 provides an access network to one or more user terminals. Examples of user terminals include smartphones, tablet devices, wearable devices, and personal computers (PCs). The AP 40 is an example of the "first communication unit."

The base station 30 is, for example, a satellite-communication base station or a base station of a mobile communication scheme such as 5G. The base station 30 connects to a wide-area network including the Internet. Communication from a user terminal to the wide-area network is via the AP 40 and the base station 30. The base station 30 and the AP 40 may be separate devices, or may be implemented as an integrated device in which the base station 30 includes the AP 40 as one of its functions. The base station 30 is an example of the "second communication unit."

The edge system 20 processes the requests of prescribed applications among the requests from user terminals. Among the requests from user terminals, the AP 40 forwards the requests of prescribed applications to the edge system 20 instead of forwarding them to the base station 30. The requests of prescribed applications that are processed by the edge system 20 are, for example, uplink transmission requests of applications with relatively low real-time requirements, such as requests to upload video data for a video-streaming application or requests to send emails in an email application.

The edge system 20 includes an edge server 21 and a storage unit 22. When the edge server 21 receives, from the user terminal that issued a request of a prescribed application, data to be transmitted in the uplink, it temporarily stores the data in the storage unit 22. In accordance with instructions from the control device 10, the edge server 21 reads, from the storage unit 22, the uplink data of prescribed applications and uploads the data, via the base station 30, to a server or other device corresponding to the application. Hereinafter, the process of reading the uplink data of prescribed applications from the storage unit 22 and uploading the data via the base station 30 to a server or other device corresponding to the application is simply referred to as "data upload."

The control device 10 monitors the remaining energy of the battery 60 and controls the starting and stopping of the edge system 20, the base station 30, and the AP 40 according to the remaining energy of the battery 60. In the first embodiment, when the

remaining energy of the battery 60 reaches a predetermined threshold, the control device 10 instructs the edge server 21 to execute a data upload. The control device 10 is an example of the "control unit."

In the first embodiment, execution of data uploads is limited to instances where the remaining energy of the battery 60 reaches a predetermined threshold. This reduces the amount of power consumed for data uploads. This extends the amount of time during which user terminals can communicate via the base station 30.

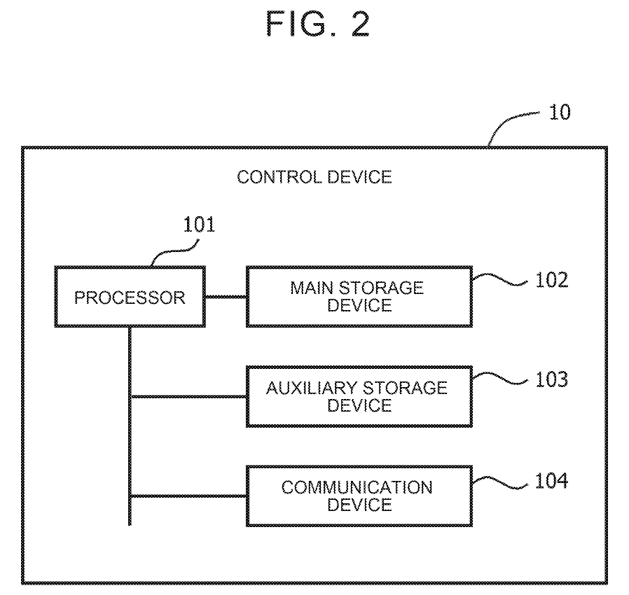

FIG. 2 shows an example of the hardware configuration of the control device 10. The control device 10 includes, as its hardware components, a processor 101, a main storage device 102, an auxiliary storage device 103, and a communication device 104. The main storage device 102 and the auxiliary storage device 103 are computer-readable recording media.

The auxiliary storage device 103 stores various programs and data used by the processor 101 during execution of these programs. The auxiliary storage device 103 may be, for example, an erasable programmable read-only memory (EPROM), a hard disk drive (HDD), or a solid-state drive (SSD). Programs held in the auxiliary storage device 103 include, for example, an operating system (OS), application programs, and system control programs.

The main storage device 102 is a storage device that provides the processor 101 with a storage area for loading programs stored in the auxiliary storage device 103 and a work area for execution, and may also be used as a buffer. The main storage device 102 includes, for example, semiconductor memories such as read-only memory (ROM) and random access memory (RAM).

The processor 101 executes various processes by loading programs stored in the auxiliary storage device 103 into the main storage device 102 and executing them. The processor 101 may be, for example, a central processing unit (CPU), a graphics processing unit (GPU), or a digital signal processor (DSP). The processor 101 is not limited to a single unit and may include multiple processors.

The communication device 104 connects to wired and wireless networks to communicate with other devices. The communication device 104 may be, for example, a network interface card (NIC), an optical transmitter and receiver for optical communication, a wireless local area network (LAN) card, or a radio circuit for connecting to a cellular

network. In the first embodiment, communication from the communication device 104 to the wide-area network is performed via the base station 30. The hardware configuration of the control device 10 shown in FIG. 2 is merely an example, and the hardware configuration of the control device 10 is not limited to the configuration shown in FIG. 2. The control device 10 may be a device including an electrical circuit such as a dedicated field-programmable gate array (FPGA) or application-specific integrated circuit (ASIC) that executes the relevant processes.

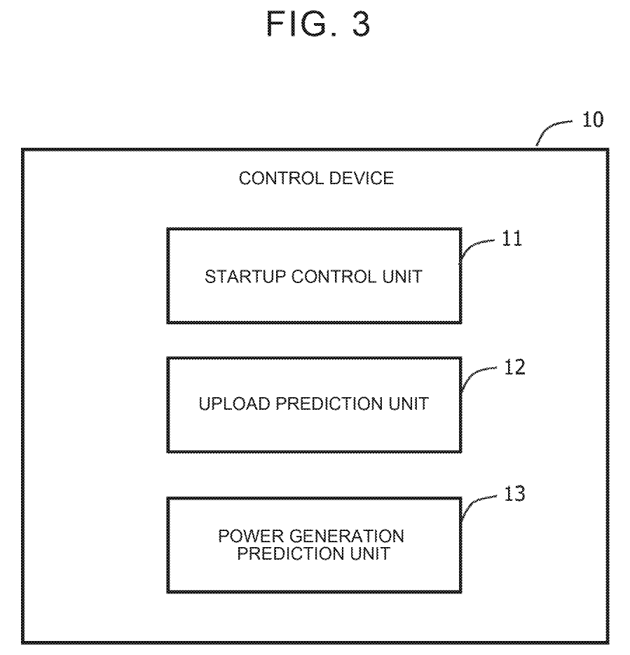

FIG. 3 shows an example of the functional configuration of the control device 10. The control device 10 includes, as functional components, a startup control unit 11, an upload prediction unit 12, and a power generation prediction unit 13. These functional components are functions implemented, for example, when the processor 101 of the control device 10 executes a system control program.

The startup control unit 11 monitors the remaining energy of the battery 60 and, according to the remaining energy, controls the starting and stopping of the edge system 20, the base station 30, and the AP 40, and the execution of data uploads by the edge server 21. The remaining energy of the battery 60 may be expressed in watt-hours (Wh) or as a percentage of the maximum capacity.

Startup thresholds and stop thresholds are set for the edge system 20, the base station 30, and the AP 40, respectively. For each of the edge system 20, the base station 30, and the AP 40, when the remaining energy of the battery 60 exceeds the corresponding startup threshold, the startup control unit 11 starts up the device. When the remaining energy of the battery 60 falls below the corresponding stop threshold, the startup control unit 11 stops the device. The startup threshold and the stop threshold may be the same value, or may be different values. The stop threshold may be higher than the startup threshold, or the startup threshold may be higher than the stop threshold. The relationships among the startup and stop thresholds for the edge system 20, the base station 30, and the AP 40 may be set as desired by the administrator of the mobile communication system 100. These relationships correspond to the order in which the edge system 20, the base station 30, and the AP 40 are started or the order in which they are stopped.

When the remaining energy of the battery 60 reaches an upload threshold, the startup control unit 11 determines to execute a data upload by the edge server 21 and instructs the edge server 21 to execute the data upload. The upload threshold is set to a value

higher than the respective startup and stop thresholds of the base station 30 and the edge system 20 (i.e., a value corresponding to higher remaining energy of the battery 60). Upon receiving an instruction to execute a data upload from the control device 10, the edge server 21 reads, from the storage unit 22, data related to predetermined requests received from user terminals and transmits (uploads) the data to a predetermined device via the base station 30. Since the remaining energy of the battery 60 fluctuates, it may frequently rise above or fall below the upload threshold. Accordingly, for example, an upper limit on the number of data uploads by the edge server 21 within a unit period such as one hour or one day may be set, or a threshold interval for data uploads by the edge server 21 may be set such that the next data upload will not be executed until at least the threshold interval has elapsed since the previous upload. Data for which upload has been completed is deleted from the storage unit 22. Thresholds related to the remaining energy of the battery 60 may be expressed in watt-hours (Wh) or as a percentage of the maximum capacity.

The upload prediction unit 12 predicts changes in the remaining energy of the battery 60 during a prediction period based on, for example, the predicted power generation amount of the generator 50 during the prediction period, the current remaining energy of the battery 60, and the total power consumption (W) of the mobile communication system 100. The predicted power generation amount of the generator 50 during the prediction period is obtained from the power generation prediction unit 13 described later.

For example, assuming that the total power consumption of the mobile communication system 100 is constant, a predicted value of the remaining energy of the battery 60 after t hours from the current time can be obtained by adding, to the current remaining energy of the battery 60, the total amount of electrical energy supplied from the generator 50 during the period from the current time to t hours later, and subtracting, from the resulting sum, the total power consumption of the mobile communication system 100 during the same period. However, the method for predicting the remaining energy of the battery 60 is not limited to any particular method. For example, the remaining energy of the battery 60 may be predicted using a machine-learning model.

The upload prediction unit 12 obtains, as the predicted upload timing, the time at which the predicted remaining energy of the battery 60 reaches or exceeds the upload threshold. The upload prediction unit 12 notifies user terminals connected to the AP 40 of the predicted upload timing through, for example, the AP 40. The notification may be

performed by, for example, broadcast, multicast, or unicast. In a case where the mobile communication system 100 is equipped with a display, the upload prediction unit 12 may present the predicted upload timing to users around the mobile communication system 100 by displaying it on the display. The predicted upload timing to be notified and/or presented may be, for example, the predicted time at which the data upload will be executed.

The power generation prediction unit 13 predicts the power generation amount of the generator 50 during a future prediction period. The prediction of the power generation amount is performed, for example, based on weather forecast information and information related to the power generation capability of the generator 50, using a predetermined method or a machine-learning model. Alternatively, the power generation prediction unit 13 may obtain a predicted power generation amount from, for example, an external server. The method used by the power generation prediction unit 13 to predict the power generation amount is not limited to any particular method.

The power generation prediction unit 13 obtains weather forecast information for an area corresponding to the location where the mobile communication system 100 is deployed, via the base station 30, from a web server or web page that provides weather forecast information. For example, a Global Positioning System (GPS) receiver may be provided in the control device 10 or in the mobile communication system 100, and the location where the mobile communication system 100 is deployed may be obtained based on location information obtained by the GPS receiver. The power generation prediction unit 13 may obtain the weather forecast information, for example, together with the execution of data uploads by the edge server 21. The weather forecast information includes information for a predetermined upcoming period, such as the weather for each one- to three-hour time slot, probability of precipitation, maximum and minimum temperatures, wind speed, wind direction, humidity, atmospheric pressure, advisories and warnings, and the forecast period.

For example, the information regarding the power generation capability of the generator 50 may be stored in advance in the auxiliary storage device 103 by the control device 10, or may be obtained by the control device 10 from the generator 50. The information regarding the power generation capability of the generator 50 includes, for example, the rated output (kW or MW) of the generator 50, a performance coefficient (capacity factor (CF)) of the generator 50, and variations in power generation depending on seasons or time periods.

The prediction period is, for example, a predetermined period such as one hour from the current time, the period from the current time to the end of the current day, or 24 hours from the current time. The prediction period may be the same as the period covered by the weather forecast information.

The power generation prediction unit 13 performs prediction of the power generation amount of the generator 50 for the prediction period, for example, in response to a request from the upload prediction unit 12. However, the present disclosure is not limited to this, and the power generation prediction unit 13 may perform the prediction at predetermined intervals such as once every several hours, once per day, once every several days, or once per week, or may obtain a prediction result from an external server or the like. The functional configuration of the control device 10 is not limited to the example shown in FIG. 3.

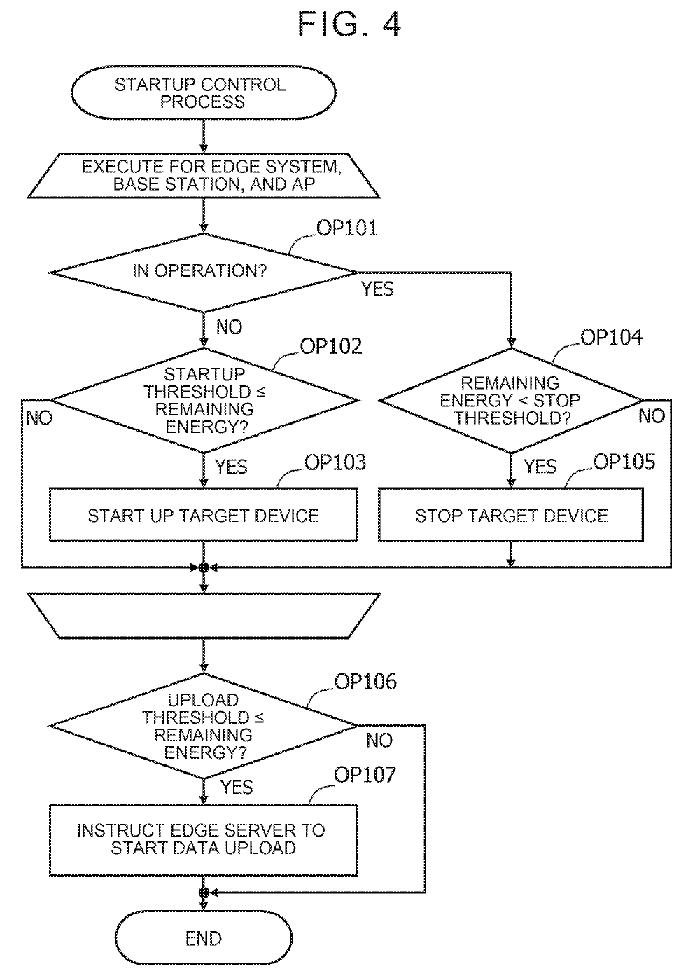

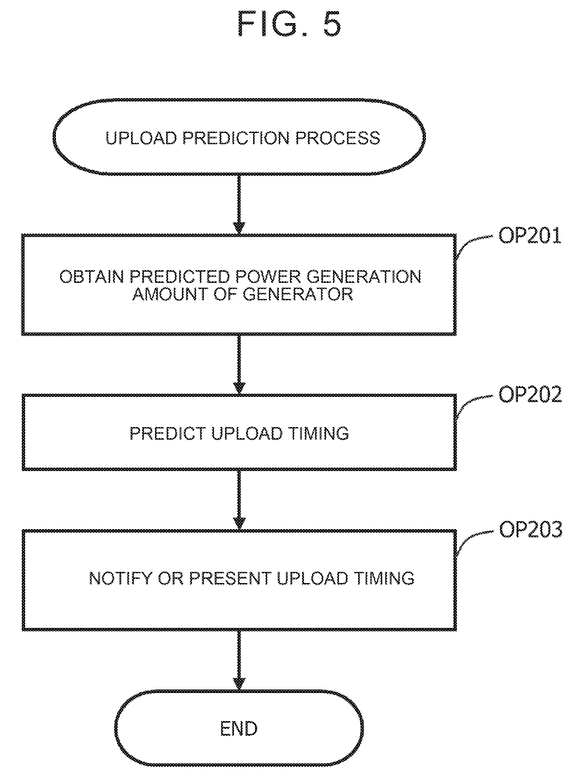

FIG. 4 is a flowchart showing an example of a startup control process executed by the control device 10. The process shown in FIG. 4 is repeatedly executed at predetermined intervals set as desired by the administrator of the mobile communication system 100, for example, at intervals of seconds, minutes, or hours. Although the process shown in FIG. 4 is executed by the processor 101, the following description refers to the functional blocks for convenience. The same applies to the flowchart shown in FIG. 5.

OP101 to OP105 are executed for each of the edge system 20, the base station 30, and the AP 40. In OP101 to OP105, the device that is the target of processing among the edge system 20, the base station 30, and the AP 40 is referred to as the target device.

In OP101, the startup control unit 11 determines whether the target device is in operation. When the target device is not in operation (OP101: NO), the process proceeds to OP102. In OP102, the startup control unit 11 determines whether the remaining energy of the battery 60 is greater than or equal to the startup threshold of the target device. When the remaining energy of the battery 60 is greater than or equal to the startup threshold (OP102: YES), the process proceeds to OP103. In OP103, the startup control unit 11 starts up the target device. When the remaining energy of the battery 60 is less than the startup threshold of the target device (OP102: NO), the process proceeds to the next device, or to OP106 when OP101 to OP105 have been completed for the edge system 20, the base station 30, and the AP 40.

When the target device is in operation (OP101: YES), the process proceeds to OP104. In OP104, the startup control unit 11 determines whether the remaining energy of the battery 60 is less than the stop threshold of the target device. When the remaining energy of the battery 60 is less than the stop threshold of the target device (OP104: YES), the process proceeds to OP105. In OP105, the startup control unit 11 stops the target device. In a case where stopping the target device would affect service, such as when the target device is executing processing in response to a request from a user terminal, the target device is stopped after it becomes safe to stop operation. When the remaining energy of the battery 60 is greater than or equal to the stop threshold of the target device (OP104: NO), the process proceeds to the next device, or to OP106 when OP101 to OP105 have been completed for the edge system 20, the base station 30, and the AP 40.

In OP106, the startup control unit 11 determines whether the remaining energy of the battery 60 is greater than or equal to the upload threshold. When the remaining energy of the battery 60 is greater than or equal to the upload threshold (OP106: YES), the process proceeds to OP107. In OP107, the startup control unit 11 instructs the edge server 21 to start uploading the data. After that, the process shown in FIG. 4 ends. However, for example, when the number of data uploads executed within a predetermined period preceding the current time has reached an upper limit, when a predetermined time has not elapsed since the previous data upload, when the amount of data waiting to be uploaded has not reached a predetermined amount, or when the traffic through the base station 30 is greater than a predetermined value, the startup control unit 11 may decide not to execute the data upload.

When, in OP106, the remaining energy of the battery 60 is less than the upload threshold (OP106: NO), the process shown in FIG. 4 ends.

FIG. 5 is a flowchart showing an example of an upload prediction process executed by the control device 10. The process shown in FIG. 5 may be repeatedly executed at predetermined intervals set as desired by the administrator of the mobile communication system 100, for example, at intervals of hours or days, or may be executed a predetermined number of times at predetermined times of day.

In OP201, the upload prediction unit 12 obtains, from the power generation prediction unit 13, the predicted power generation amount of the generator 50 for the prediction period. In OP202, the upload prediction unit 12 predicts the change in the

remaining energy of the battery 60 during the prediction period based on, for example, the predicted power generation amount of the generator 50, the current remaining energy of the battery 60, and the overall power consumption of the mobile communication system 100, and obtains, as the predicted upload timing, the predicted time at which the remaining energy will reach or exceed the upload threshold.

In OP203, the upload prediction unit 12 notifies user terminals, via the AP 40, of the predicted time at which the data upload will be executed, or presents the predicted time by displaying it on a display provided in the mobile communication system 100. However, the present disclosure is not limited to this, and the upload prediction unit 12 may instruct the edge server 21 to notify user terminals that access the edge server 21 of the predicted time at which the data upload will be executed. After that, the process shown in FIG. 5 ends.

### Functions and Effects of First Embodiment

In the first embodiment, execution of data uploads, which consume a relatively large amount of power in the mobile communication system 100, is limited to instances where the remaining energy of the battery 60 reaches the upload threshold. This reduces the amount of power consumed for data uploads and allows the saved power to be allocated, for example, to communication by user terminals via the base station 30, thereby extending the amount of time during which communication via the base station 30 can be performed.

### Other Embodiments

The above embodiment is merely an example, and various modifications may be made without departing from the spirit and scope of the disclosure.

In the first embodiment, the control device 10 and the edge server 21 are provided as separate devices. However, the control device 10 and the edge server 21 may be implemented as a single device. In other words, the edge server 21 may also serve as the control device 10 and execute the processes shown in FIGS. 4 and 5.

The processes and means described in the present disclosure may be freely combined as long as no technical inconsistency arises.

A process described as being executed by one device may instead be shared and executed by a plurality of devices. Alternatively, a process described as being executed by different devices may be executed by a single device. In a computer system, the hardware configuration (server configuration) used to implement each function can be modified flexibly.

The present disclosure may also be implemented by supplying to a computer a computer program that implements the functions described in the above embodiment, and causing one or more processors of the computer to read and execute the program. Such a computer program may be provided to the computer via a non-transitory computer-readable storage medium connectable to a system bus of the computer, or may be provided to the computer via a network. The non-transitory computer-readable storage medium may be, for example, any type of disk such as a magnetic disk (floppy (registered trademark) disk, hard disk drive (HDD), etc.) or an optical disc (compact disc read-only memory (CD-ROM), digital versatile disc (DVD), Blu-ray disc, etc.), a read-only memory (ROM), a random access memory (RAM), an erasable programmable read-only memory (EPROM), an electrically erasable programmable read-only memory (EEPROM), a magnetic card, a flash memory, an optical card, or any type of medium suitable for storing electronic instructions.

What is claimed is:

1. A system comprising:
a generator that uses renewable energy;
a battery configured to store electric power supplied from the generator;
a first communication unit that is powered by the battery and configured to provide an access network;
a second communication unit that is powered by the battery and configured to connect to a wide area network;
a server that is powered by the battery and configured to process a predetermined request from one or more terminals through the first communication unit;
a storage unit configured to store data received from the one or more terminals in association with the predetermined request; and
a control unit configured to, when remaining energy of the battery reaches a predetermined threshold, instruct the server to start uploading of the data stored in the storage unit to a predetermined device through the second communication unit.

2. The system according to claim 1, wherein the control unit is further configured to
obtain a prediction result of a power generation amount of the generator,
predict an upload timing based on the prediction result of the power generation amount, the remaining energy of the battery, and power consumption of the system, and
notify the one or more terminals of a prediction result of the upload timing, or present the prediction result of the upload timing by a predetermined method.

3. The system according to claim 1, wherein the control unit is further configured to
control starting and stopping of the first communication unit, starting and stopping of the second communication unit, starting or stopping of the server, and start of the uploading, according to the remaining energy of the battery.

4. The system according to claim 1, wherein the system is transportable by including a mobile object or by being mountable on a mobile object.

5. A method implemented in a system including
a generator that uses renewable energy,
a battery configured to store electric power supplied from the generator,
a first communication unit that is powered by the battery and configured to provide an access network,
a second communication unit that is powered by the battery and configured to connect to a wide area network,
a server that is powered by the battery,
a storage unit, and
a control unit, the method comprising:
processing, by the server, a predetermined request from one or more terminals through the first communication unit;
storing, by the server, data received from the one or more terminals in association with the predetermined request; and
when remaining energy of the battery reaches a predetermined threshold, instructing, by the control unit, the server to start uploading of the data stored in the storage unit to a predetermined device through the second communication unit.
